(19) United States
(12) Patent Application Publication
(10) Pub. No.: US 2023/0237853 A1
(43) Pub. Date: Jul. 27, 2023

(54) INFORMATION PROCESSING APPARATUS, STORAGE MEDIUM, AND INFORMATION PROCESSING METHOD

(71) Applicant: TOYOTA JIDOSHA KABUSHIKI KAISHA, Toyota-shi (JP)

(72) Inventor: Toshiki KASHIWAKURA, Tokyo (JP)

(21) Appl. No.: 18/055,881

(22) Filed: Nov. 16, 2022

(30) Foreign Application Priority Data
Jan. 25, 2022 (JP) 2022-009682

(51) Int. Cl. G07B 15/02; G06Q 30/02

(52) U.S. Cl. CPC G07B 15/02; G06Q 30/0284

(57) ABSTRACT

An information processing apparatus communicable with a reader provided in a parking lot includes a controlling portion. The controlling portion executes an operation including: detecting a vehicle by the reader; detecting one or more vacant spots from among parking spots in the parking lot; calculating a parking fee for each of the one or more vacant spots; and notifying a user of the vehicle of the calculated parking fee.

### CROSS-REFERENCE TO RELATED APPLICATION

This application claims priority to Japanese Patent Application No. 2022-009682 filed on Jan. 25, 2022, incorporated herein by reference in its entirety.

### BACKGROUND

### 1. Technical Field

This disclosure relates to an information processing apparatus, a storage medium, and an information processing method.

### 2. Description of Related Art

A technology to set a parking fee corresponding to a future demand for a parking lot such that the future demand for the parking lot is predicted and a parking fee for the parking lot is calculated in accordance with the future demand has been disclosed (for example, Japanese Unexamined Patent Application Publication No. 2016-212587 A (JP 2016-212587 A)).

### SUMMARY

In the related art, the parking fee does not change depending on parking spots in the parking lot. Accordingly, convenient parking spots are filled with vehicles in order of arrival, and in some cases, vehicles are parked there for a long period of time.

An object of this disclosure accomplished in view of such circumstances is to provide an information processing apparatus, a storage medium, and an information processing method each of which can set different parking fees for respective parking spots.

An information processing apparatus according to one aspect of this disclosure is an information processing apparatus communicable with a reader provided in a parking lot. The information processing apparatus includes a controlling portion. The controlling portion executes an operation including the followings: detecting a vehicle by the reader; detecting one or more vacant spots from among parking spots in the parking lot; calculating a parking fee for each of the one or more vacant spots; and notifying a user of the vehicle of the calculated parking fee.

A storage medium storing a program according to one aspect of this disclosure is a storage medium storing a program causing a computer serving as an information processing apparatus communicable with a reader provided in a parking lot to execute an operation including the followings: detecting a vehicle by the reader; detecting one or more vacant spots from among parking spots in the parking lot; calculating a parking fee for each of the one or more vacant spots; and notifying a user of the vehicle of the calculated parking fee.

An information processing method according to one aspect of this disclosure is an information processing method to be executed by an information processing apparatus communicable with a reader provided in a parking lot. The information processing method includes: detecting a vehicle by the reader; detecting one or more vacant spots from among parking spots in the parking lot; calculating a parking fee for each of the one or more vacant spots; and notifying a user of the vehicle of the calculated parking fee.

With the information processing apparatus, the storage medium, and the information processing method according to the above aspects of this disclosure, it is possible to set different parking fees for respective parking spots.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating an information processing system;

FIG. 2 is a block diagram illustrating a configuration of an information processing apparatus;

FIG. 3 is a block diagram illustrating a configuration of a user terminal;

FIG. 4 is a view illustrating a parking lot;

FIG. 5 is a view illustrating a data structure of a fee database (DB);

FIG. 6 is a view illustrating one example of a display screen of a display device;

FIG. 7 is a view illustrating a data structure of a usage status DB; and

FIG. 8 is a flowchart illustrating the operation of the information processing apparatus.

### DETAILED DESCRIPTION OF EMBODIMENTS

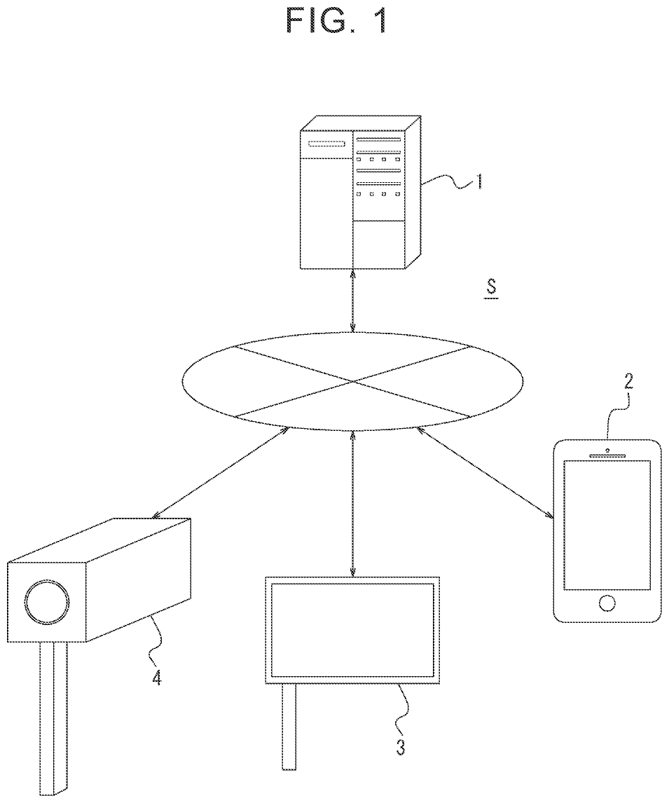

FIG. 1 is a schematic view illustrating an information processing system S of the present embodiment. The information processing system S includes an information processing apparatus 1, a user terminal 2, a display device 3, and a reader 4 communicable with each other via a network NW. The network NW includes, for example, a mobile communication network and the Internet.

For simplification of the description, FIG. 1 illustrates one information processing apparatus 1, one user terminal 2, one display device 3, and one reader 4. However, the number of information processing apparatuses 1, the number of user terminals 2, the number of display devices 3, and the number of readers 4 are not limited to this. For example, a process to be executed by the information processing apparatus 1 of the present embodiment may be executed by a plurality of information processing apparatuses 1 arranged distributively. A plurality of user terminals 2 may be operated by a user. A plurality of display devices 3 or a plurality of readers 4 may be provided.

An outline of a process to be executed by the information processing apparatus 1 of the present embodiment will be described. When a controlling portion 11 of the information processing apparatus 1 executes an operation including: detecting a vehicle by the reader 4; detecting one or more vacant spots from among parking spots in a parking lot; calculating a parking fee for each of the one or more vacant spots; and notifying a user of the vehicle of the calculated parking fee. With this configuration, the information processing apparatus 1 can set different parking fees for respective parking spots, thereby making it possible to achieve an efficient parking arrangement.

The information processing apparatus 1 is provided in a facility such as a data center. The information processing apparatus 1 is a computer such as a server belonging to a cloud computing system or other computing systems.

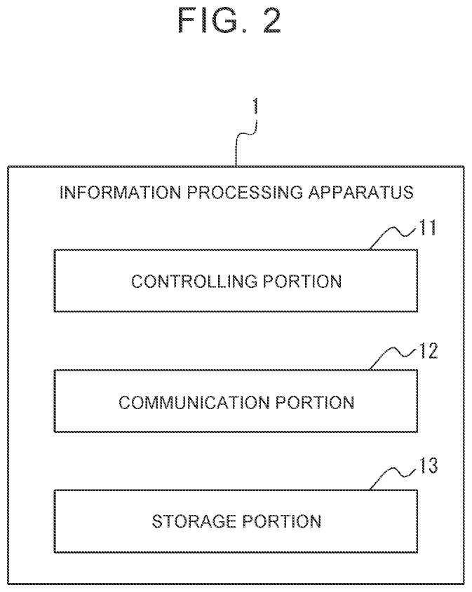

With reference to FIG. 2, the following describes details of an inner configuration of the information processing apparatus 1.

The information processing apparatus 1 includes the controlling portion 11, a communication portion 12, and a storage portion 13. The constituents of the information processing apparatus 1 are connected communicably with each other via an exclusive line, for example.

The controlling portion 11 includes, for example, one or more general purpose processors including a central processing unit (CPU) and a micro processing unit (MPU). The controlling portion 11 may include one or more dedicated processors specialized in specific processes. The controlling portion 11 may include one or more dedicated circuits, instead of including processors. The dedicated circuit may be, for example, a field-programmable gate array (FPGA) or an application specific integrated circuit (ASIC). The controlling portion 11 may include an electronic control unit (ECU). The controlling portion 11 transmits and/or receives given information via the communication portion 12.

The communication portion 12 includes a communications module corresponding to one or more wired or wireless local area network (LAN) standards so as to be connected to the network NW. The communication portion 12 may include a module corresponding to one or more mobile communications standards such as Long Term Evolution (LTE), 4th-Generation (4G), or 5th-Generation (5G). The communication portion 12 may include a communications module or the like corresponding to one or more short-distance communications standards or specifications including Bluetooth (registered trademark), AirDrop (registered trademark), IrDA, ZigBee (registered trademark), Felica (registered trademark), or RFID. The communication portion 12 transmits and/or receives given information via the network NW.

The storage portion 13 includes, for example, a semiconductor memory, a magnetic memory, an optical memory, or a combination of at least two types of memories from among them but is not limited to them. The semiconductor memory is a RAM or a ROM, for example. The RAM is an SRAM or a DRAM, for example. The ROM is an EEPROM, for example. The storage portion 13 may function as a main storage device, an auxiliary storage device, or a cache memory, for example. In the storage portion 13, information on a result of an analysis or a process performed by the controlling portion 11 may be stored. In the storage portion 13, various pieces of information or the like on an operation or a control of the information processing apparatus 1 may be stored. In the storage portion 13, a system program, an application program, embedded software, and so on may be stored. The storage portion 13 is provided outside the information processing apparatus 1 and may be accessed from the information processing apparatus 1. The storage portion 13 includes a fee DB and a usage status DB (described later).

The user terminal 2 is a terminal operated by a user. The user terminal 2 is a mobile device such as a mobile phone device, a smartphone, a wearable device, or a tablet, for example. As an alternative example, the user terminal 2 may be a general-purpose device such as a PC or a dedicated device. Here, “PC” is an abbreviation of Personal Computer.

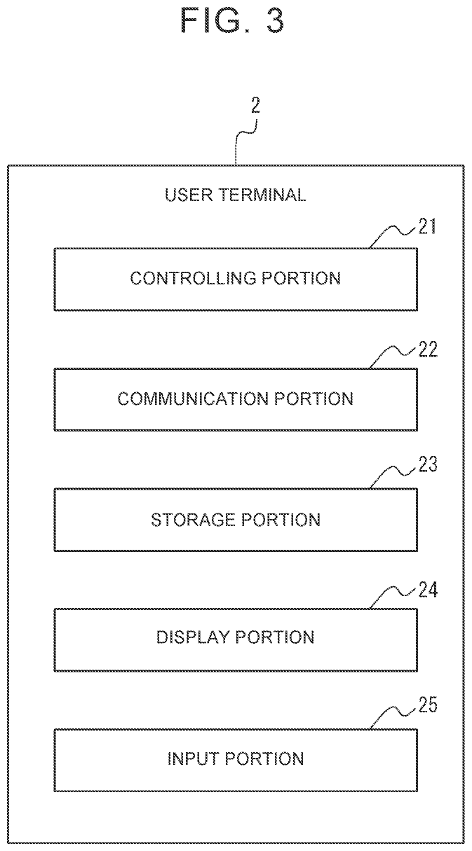

With reference to FIG. 3, the following describes details of an inner configuration of the user terminal 2.

The user terminal 2 includes a controlling portion 21, a communication portion 22, a storage portion 23, a display portion 24, and an input portion 25. The constituents of the user terminal 2 are connected communicably with each other via an exclusive line, for example.

Descriptions on respective hardware configurations of the controlling portion 21, the communication portion 22, and the storage portion 23 of the user terminal 2 may be the same as the descriptions on respective hardware configurations of the controlling portion 11, the communication portion 12, and the storage portion 13 of the information processing apparatus 1. The descriptions on them here are omitted.

The display portion 24 is, for example, a display. The display is, for example, an LCD or an organic EL display. Here, “LCD” is an abbreviation of Liquid Crystal Display. Further, “EL” is an abbreviation of Electro Luminescence. Instead of being provided in the user terminal 2, the display portion 24 may be connected to the user terminal 2 as an external output device. As a connection method, any method such as USB, HDMI (registered trademark), or Bluetooth (registered trademark) can be used, for example. The “USB” is an abbreviation of Universal Serial Bus. The “HDMI” (registered trademark) is an abbreviation of High-Definition Multimedia Interface.

A display content to be displayed on the display portion 24 may be displayed by an application installed in the user terminal 2.

The input portion 25 is, for example, a physical key, an electrostatic capacitive key, a pointing device, a touchscreen provided integrally with a display, or a microphone. The input portion 25 receives an operation to input information to be used for the operation of the user terminal 2. Instead of being provided in the user terminal 2, the input portion 25 may be connected to the user terminal 2 as an external input device. As a connection method, any method such as USB, HDMI (registered trademark), or Bluetooth (registered trademark) can be used, for example.

The display device 3 is a display, for example. The display is, for example, an LCD or an organic EL display. The display device 3 may be provided to stand or may be embedded in the ground or floor. Alternatively, the display device 3 may be a projector. In this case, the display device 3 can project a given image on the ground, the floor, or the wall of a parking lot P.

The display device 3 may include a speaker. The display device 3 may notify the user of a display content by sound. The notification in the present embodiment may include at least one of notification by screen display and notification by sound.

The reader 4 is a device configured to capture an image by use of a camera and read information in the image. The reader 4 of the present embodiment reads number information described on a number plate of a vehicle.

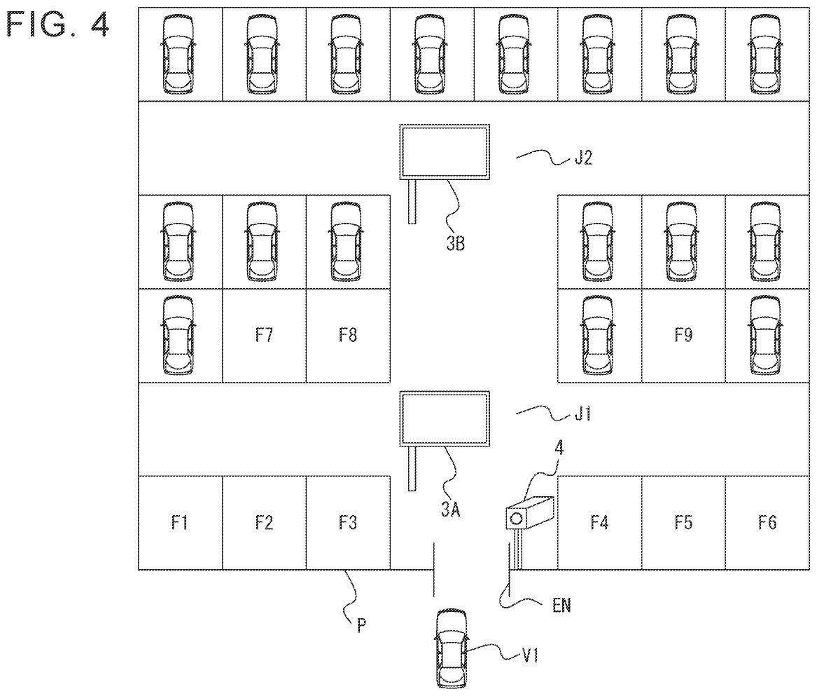

The following describes details of a process to be executed by the information processing system S of the present embodiment. As one example, the following deals with a scene where a vehicle V1 driven by a user is parked in the parking lot P as illustrated in FIG. 4.

The parking lot P includes one or more parking spots. One vehicle can be parked in one parking spot. In the example illustrated in FIG. 4, parking spots F1 to F9 are vacant spots. Vacant spot information may be provided by an administrator of the parking lot P.

The reader 4 may be provided in an entrance EN of the parking lot P. The reader 4 reads identification information (here a number) on the vehicle V1 to enter the parking lot P. A plurality of readers 4 may be provided in the parking lot P to capture images of all places inside the parking lot P.

The parking lot P includes one or more intersections. An intersection J1 and an intersection J2 are illustrated in FIG. 4. An intersection is a part where two or more roads (or passages) intersect with each other. The intersection may be any of the followings, for example.
A junction of three roads (including a T-shaped intersection or a Y-shaped intersection)
A junction of four roads (including a crossroads)

The display device 3 is provided in each of the intersections. As illustrated in FIG. 4, a display device 3A is provided in the intersection J1. A display device 3B is provided in the intersection J2. The display device 3 is recognized visually by the user who is driving the vehicle V1. As an alternative example, the display device 3 may be provided in each of the parking spots.

The controlling portion 11 of the information processing apparatus 1 regularly or irregularly detects vacant spots in the parking lot P. The controlling portion 11 calculates a parking fee for each of the vacant spots. For example, when the vehicle V1 is detected by the reader 4, for example, the controlling portion 11 may calculate a parking fee for each of the vacant spots. The parking fee may be calculated, for example, based on at least one of the following pieces of information.
A distance from the entrance EN
Whether or not a parking spot affects the movement line of a self-driving vehicle
A degree of difficulty in parking

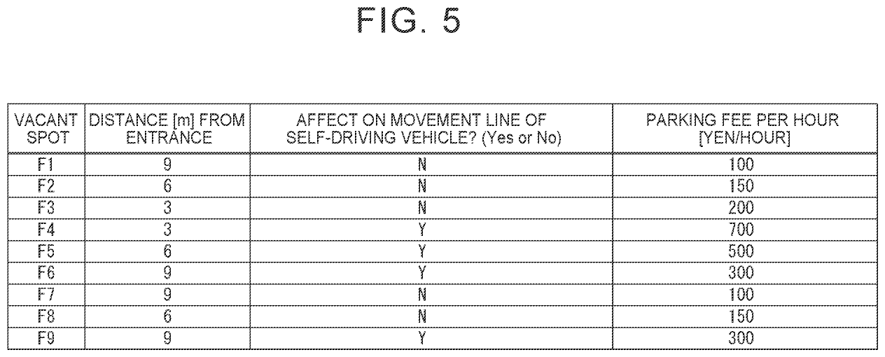

In the fee DB of FIG. 5, the distance from the entrance EN and whether or not the parking spot affects the movement line of the self-driving vehicle are stored in association with the parking spot. Information indicative of the distance from the entrance EN may be provided by the administrator of the parking lot P, for example. Information on whether or not the parking spot affects the movement line of the self-driving vehicle may be any of the following pieces of information, for example.
Whether or not a vacant spot is a parking spot where the self-driving vehicle is planned to park
Whether or not a range where a vehicle passes at the time of parking in the vacant spot overlaps with a range where the self-driving vehicle passes

As illustrated in FIG. 5, the controlling portion 11 calculates a parking fee for a vacant spot such that the parking fee is lower as the vacant spot is more distant from the entrance EN. The controlling portion 11 calculates a parking fee for a vacant spot that does not affect the movement line of the self-driving vehicle such that the parking fee is lower than a parking fee for a vacant spot that affects the movement line of the self-driving vehicle. The movement line of the self-driving vehicle is stored in the storage portion 13 in advance.

As an alternative example or an additional example, the controlling portion 11 may calculate the parking fee such that the parking fee is lower as the vacant spot has a higher degree of difficulty in parking. The degree of difficulty in parking may be registered in the storage portion 13 in advance.

When the controlling portion 11 detects the vehicle V1 based on information acquired from the reader 4, the controlling portion 11 notifies the user of calculated parking fees. More specifically, the controlling portion 11 displays the parking fees on the display device 3.

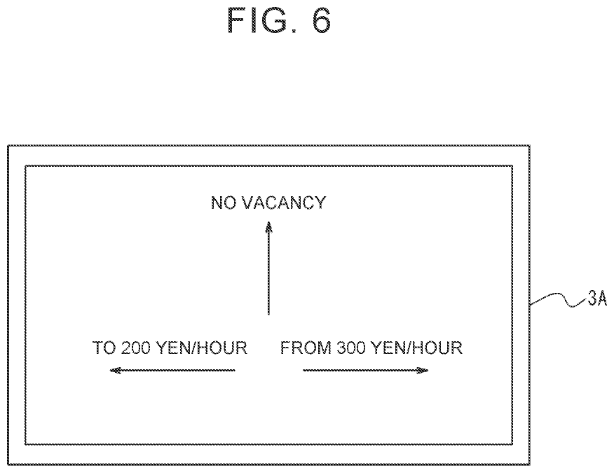

For example, in a case where the vehicle V1 turns right at the position of the display device 3A, the parking spots F4, F5, F6, F9 are present on a passage on the right side from the intersection J1. As illustrated in FIG. 5, the fees of these four parking spots fall within a range from 300 yen/h to 700 yen/h. As illustrated in FIG. 6, the controlling portion 11 displays, on the display device 3, information indicating that the minimum fee is 300 yen/h. As an alternative example, the controlling portion 11 may display, on the display device 3, respective parking fees of the vacant spots or may be display, on the display device 3, only the maximum fee among them. As another alternative example, the controlling portion 11 may display an image of the parking lot P and may display respective parking fees of the vacant spots such that the respective parking fees are superimposed on the vacant spots.

As an alternative example, when the controlling portion 11 detects the vehicle V1 by the reader 4, the controlling portion 11 identifies the user of the vehicle V1 by referring to a table in which the vehicle V1 and the user of the vehicle V1 are stored in association with each other. The table is included in the storage portion 13. The controlling portion 11 notifies the user terminal 2 of the identified user of the calculated parking fees. The display portion 24 of the user terminal 2 displays the parking fees. As another alternative example, when the controlling portion 11 detects the vehicle V1, the controlling portion 11 may display the calculated parking fees on a display portion (e.g., a car navigation system screen) of the vehicle V1.

In a case where the vehicle V1 turns left at the position of the display device 3A, the parking spots F1, F2, F3, F7, F8 are present on a passage on the left side from the intersection J1. A determination method for determining a display content on the display device 3A in this case may be the same as the determination method for determining a display content in a case where the vehicle V1 turns right at the position of the display device 3A. The descriptions here are omitted. A determination method for determining a display content on the display device 3B may be the same as the determination method for determining a display content on the display device 3A. The descriptions here are omitted.

In a case where the vehicle V1 goes straight at the position of the display device 3A, there is no vacant spot ahead of the position of the display device 3A. As illustrated in FIG. 6, the controlling portion 11 displays, on the display device 3A, information indicating that there is no vacant spot.

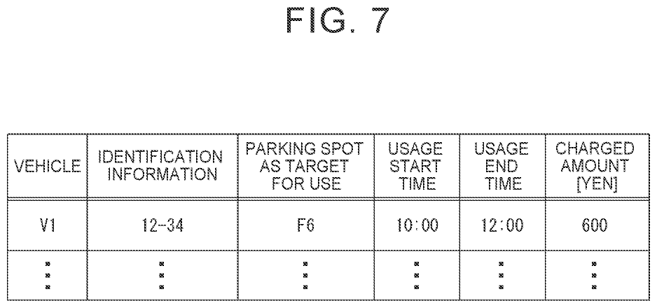

The controlling portion 11 detects which vacant spot the vehicle V1 is parked in, based on information acquired from the reader 4. The reader 4 may be a reader 4 provided in the entrance EN or may be another reader 4 provided in each parking spot or the like. As illustrated in FIG. 7, the controlling portion 11 stores, in the usage status DB, the following information in association with the vehicle V1.
Identification information (here, number information)
A parking spot as a target for use
Usage start time of the parking spot
Usage end time of the parking spot

The controlling portion 11 determines a usage time range based on the usage start time and the usage end time stored in the usage status DB. The controlling portion 11 calculates the amount charged to the vehicle V1 based on the usage time range and a fee per hour stored in the fee DB. The controlling portion 11 further stores the amount charged to the vehicle V1 in the usage status DB.

As an additional example, in a case where the vehicle V1 moves to an alternative parking spot, the controlling portion 11 detects again which vacant spot the vehicle V1 is parked in. The controlling portion 11 adds a new record to the usage status

DB in terms of the use in the alternative parking spot. The controlling portion 11 calculates a charged amount in terms of the use in the alternative parking spot.

As an additional example or an alternative example, when the controlling portion 11 determines a parking spot in which vehicle V1 is parked, the controlling portion 11 may notify the user terminal 2 of the parking spot thus determined.

As an additional example or an alternative example, the controlling portion 11 may provide discount information to the user of the vehicle V1 using the parking spot. For example, when the controlling portion 11 determines, based on the usage status DB, that the vehicle V1 uses the parking lot P, the controlling portion 11 determines whether or not the identification information of the vehicle V1 is registered in advance, by referring to the storage portion 13. In a case where the identification information of the vehicle V1 is registered in advance, the controlling portion 11 may notify the user terminal 2 registered in association with the identification information that the parking fee is reduced by a predetermined amount when the user spends at least a predetermined amount of money for shopping in a store associated with the parking lot P. The notification content is displayed on the display portion 24 of the user terminal 2, so that the notification content is presented to a staff in the store at the time of shopping. The notification content may be in the form of QR Code (registered trademark). When the QR Code is read by a reader provided in the store, the information processing apparatus 1 may be notified that a discount is applied to the parking fee. A user of a vehicle the identification information of which is unregistered cannot receive a discount.

When the vehicle V1 goes out of the parking lot P, the controlling portion 11 reads the identification information of the vehicle V1 by the reader 4. When the controlling portion 11 determines that an automatic settlement function is set in the vehicle V1, the controlling portion 11 may automatically settle a charged amount by charging the charged amount to a billing destination (e.g., credit card information) registered in advance.

Flowchart

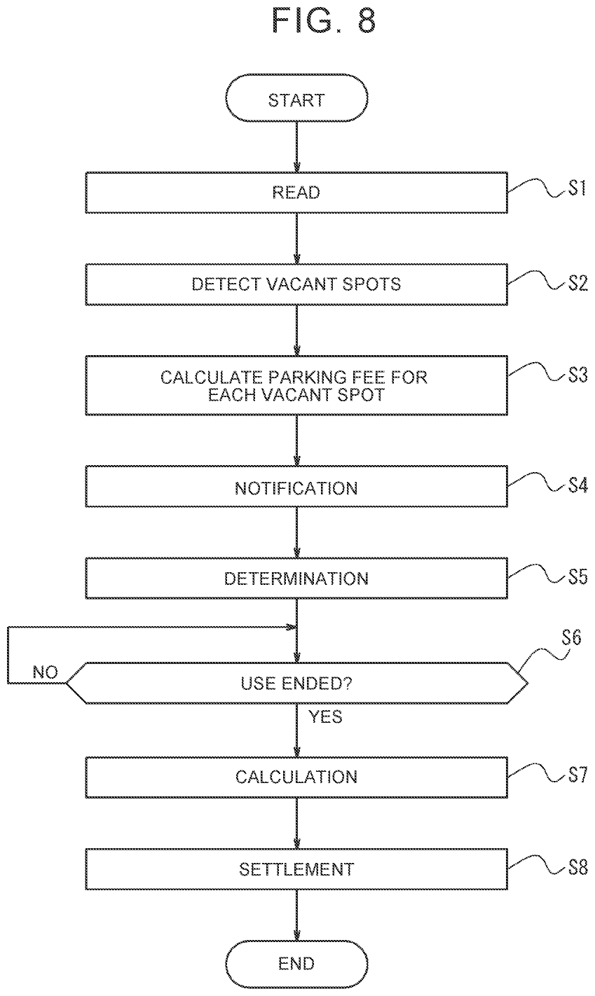

With reference to FIG. 8, an information processing method to be executed by the controlling portion 11 of the information processing apparatus 1 will be described.

In step S1, the controlling portion 11 reads identification information on the vehicle V1 using the parking lot P by the reader 4. As an alternative example, step S1 may be executed at a given timing before step S5.

In step S2, the controlling portion 11 detects vacant spots in the parking lot P.

In step S3, the controlling portion 11 calculates a parking fee for each of the vacant spots. Since the calculation method of the parking fee has been described above, the calculation method is not described herein.

In step S4, the controlling portion 11 notifies the user of the vehicle V1 of the calculated parking fee.

In step S5, the controlling portion 11 determines a parking spot in which vehicle V1 is parked, and a usage time range of the parking spot.

In step S6, the controlling portion 11 determines whether the use of the parking spot is ended or not.

When a negative determination (No) is made in step S6, the controlling portion 11 executes step S6 again.

When a positive determination (Yes) is made in step S6, the controlling portion 11 calculates the amount charged to the user of the vehicle V1 in step S7.

In step S8, the controlling portion 11 settles the calculated charged amount. The settlement may be performed automatically.

In the present embodiment, the controlling portion 11 executes an operation including the followings: detecting a vehicle by the reader 4; detecting one or more vacant spots from among parking spots in a parking lot; calculating a parking fee for each of the one or more vacant spots; and notifying a user of the vehicle of the calculated parking fee. With this configuration, the information processing apparatus 1 can set different parking fees for respective parking spots, thereby making it possible to achieve an efficient parking arrangement.

Further, in the present embodiment, the operation of the controlling portion 11 includes calculating the parking fee for the each of the one or more vacant spots based on at least one of a distance from an entrance of the parking lot, whether or not the each of the one or more vacant spots affects the movement line of a self-driving vehicle, and a degree of difficulty in parking. With this configuration, when the information processing apparatus 1 sets a high parking fee for a parking spot near from the entrance of the parking lot, it is possible to reduce a problem such as long-term parking in a convenient spot, for example.

Further, in the present embodiment, the operation includes displaying the calculated parking fee on a display device provided in an intersection in the parking lot. With the above configuration, the information processing apparatus 1 can provide information on which direction the vehicle should move to at the intersection to find a vacant spot and information on how much the parking fee of the vacant spot is. This makes it possible to improve convenience for the user.

Further, in the present embodiment, the operation includes notifying the user terminal 2 to be operated by the user of the detected vehicle of the calculated parking fee. With this configuration, the information processing apparatus 1 can provide information on how much the parking fee of the vacant spot is. This makes it possible to improve convenience for the user.

Further, in the present embodiment, the operation includes: determining, by the reader 4, a parking spot in which the vehicle is parked, and a usage time range of the parking spot; and calculating the amount charged to the user of the vehicle based on the parking spot, the usage time range, and the calculated parking fee. The operation further includes, when the controlling portion 11 determines that the use of the parking lot by the vehicle is ended, automatically settling the charged amount. With this configuration, the information processing apparatus 1 can reduce troubles for the user to settle the charged amount.

Further, in the present embodiment, the operation includes: determining, by the reader 4, a parking spot in which the vehicle is parked; and notifying the user terminal 2 to be operated by the user of the vehicle of the determined parking spot. With this configuration, the information processing apparatus 1 allows the user leaving the parking lot to easily find the parking spot when the user comes back to the parking lot.

This disclosure is described based on the drawings and the embodiment, but it should be noted that a person skilled in the art can easily make various modifications and alterations based on this disclosure. Furthermore, this disclosure is modifiable within a range that does not depart from the gist of the disclosure. For example, a function or the like included in each means or each step can be rearranged as far as the rearrangement is not logically inconsistent, and a plurality of means or steps may be combined into one or may be divided.

For example, in the above embodiment, programs to execute all of or some of the functions or the processes of the information processing apparatus 1 can be stored in a computer-readable recording medium. The computer-readable recording medium includes a non-transitory computer readable medium and is, for example, a magnetic recorder, an optical disc, a magneto-optical recording medium, or a semiconductor memory. The distribution of the programs is performed, for example, by selling, transferring, or lending portable recording media such as digital versatile discs (DVDS) or compact disc read only memory (CD-ROMS) in which the programs are stored. Further, the programs may be distributed by storing the programs in a storage of a given server and transferring the programs to other computers from a given server. Further, the programs may be provided as program products. This disclosure is also achievable as a program executable by a processor.

The computer temporarily stores, for example, in a main storage device, the program stored in the portable recording medium or the program transferred from a server. Then, the computer reads, by the processor, the program stored in the main storage device and executes, by the processor, a process in accordance with the program thus read. The computer may directly read the program from the portable recording medium and execute the process in accordance with the program. The computer may sequentially execute the process in accordance with the program every time the program is transferred to the computer from the server. The process may be executed by a so-called ASP service that implements the function only by an execution instruction and result acquisition without transferring the program from the server to the computer. The “ASP” is an abbreviation of Application Service Provider. The program includes information used for processing by an electronic computer and an equivalent to the program. For example, data that is not a direct command to the computer but has a property defining the processing of the computer corresponds to the “equivalent to the program.”

What is claimed is:

1. An information processing apparatus communicable with a reader provided in a parking lot, the information processing apparatus comprising a controlling portion, wherein the controlling portion executes an operation including the followings:
detecting a vehicle by the reader;
detecting one or more vacant spots from among parking spots in the parking lot;
calculating a parking fee for each of the one or more vacant spots; and
notifying a user of the vehicle of the calculated parking fee.

2. The information processing apparatus according to claim 1, wherein the operation includes calculating the parking fee for the each of the one or more vacant spots based on at least one of a distance from an entrance of the parking lot, whether or not the each of the one or more vacant spots affects a movement line of a self-driving vehicle, and a degree of difficulty in parking.

3. The information processing apparatus according to claim 1, wherein the operation includes displaying the calculated parking fee on a display device provided in an intersection in the parking lot.

4. The information processing apparatus according to claim 1, wherein the operation includes notifying a user terminal to be operated by the user of the detected vehicle of the calculated parking fee.

5. The information processing apparatus according to claim 1, wherein the operation includes:
determining, by the reader, a parking spot in which the vehicle is parked, and a usage time range in the parking spot; and
calculating an amount charged to the user of the vehicle based on the parking spot, the usage time range, and the calculated parking fee.

6. The information processing apparatus according to claim 5, wherein the operation includes, when the controlling portion determines that use of the parking lot by the vehicle is ended, automatically settling the amount charged to the user.

7. The information processing apparatus according to claims 1, wherein the operation includes:
determining, by the reader, a parking spot in which vehicle is parked; and
notifying a user terminal to be operated by the user of the vehicle of the determined parking spot.

8. A non-transitory storage medium storing a program causing a computer serving as an information processing apparatus communicable with a reader provided in a parking lot to execute an operation including the followings:
detecting a vehicle by the reader;
detecting one or more vacant spots from among parking spots in the parking lot;
calculating a parking fee for each of the one or more vacant spots; and
notifying a user of the vehicle of the calculated parking fee.

9. The non-transitory storage medium according to claim 8, wherein the operation includes calculating the parking fee for the each of the one or more vacant spots based on at least one of a distance from an entrance of the parking lot, whether or not the each of the one or more vacant spots affects a movement line of a self-driving vehicle, and a degree of difficulty in parking.

10. The non-transitory storage medium according to claim 8, wherein the operation includes displaying the calculated parking fee on a display device provided in an intersection in the parking lot.

11. The non-transitory storage medium according to claim 8, wherein the operation includes notifying a user terminal to be operated by the user of the detected vehicle of the calculated parking fee.

12. The non-transitory storage medium according to claim 8, wherein the operation includes:
determining, by the reader, a parking spot in which the vehicle is parked, and a usage time range in the parking spot; and
calculating an amount charged to the user of the vehicle based on the parking spot, the usage time range, and the calculated parking fee.

13. The non-transitory storage medium according to claim 12, wherein the operation includes, when use of the parking lot by the vehicle is determined to be ended, automatically settling the amount charged to the user.

14. The non-transitory storage medium according to claim 8, wherein the operation includes:
determining, by the reader, a parking spot in which vehicle is parked; and
notifying a user terminal to be operated by the user of the vehicle of the determined parking spot.

15. An information processing method to be executed by an information processing apparatus communicable with a reader provided in a parking lot, the information processing method comprising:
detecting a vehicle by the reader;
detecting one or more vacant spots from among parking spots in the parking lot;
calculating a parking fee for each of the one or more vacant spots; and
notifying a user of the vehicle of the calculated parking fee.

16. The information processing method according to claim 15, comprising calculating the parking fee for the each of the one or more vacant spots based on at least one of a distance from an entrance of the parking lot, whether or not the each of the one or more vacant spots affects a movement line of a self-driving vehicle, and a degree of difficulty in parking.

17. The information processing method according to claim 15, comprising displaying the calculated parking fee on a display device provided in an intersection in the parking lot.

18. The information processing method according to claim 15, comprising notifying a user terminal to be operated by the user of the detected vehicle of the calculated parking fee.

19. The information processing method according to claim 15, comprising:
determining, by the reader, a parking spot in which the vehicle is parked, and a usage time range in the parking spot; and
calculating an amount charged to the user of the vehicle based on the parking spot, the usage time range, and the calculated parking fee.

20. The information processing method according to claim 19, comprising, when use of the parking lot by the vehicle is determined to be ended, automatically settling the amount charged to the user.
